(19) United States
(12) Patent Application Publication
(10) Pub. No.: US 2026/0178380 A1
(43) Pub. Date: Jun. 25, 2026

(54) TASK PROCESSING

(71) Applicant: Beijing Zitiao Network Technology Co., Ltd., Beijing (CN)

(72) Inventors: Chi FANG, Beijing (CN); Mengqian LIU, Beijing (CN); Jia GUO, Beijing (CN); Xujie TAO, Beijing (CN); Shuo LIU, Beijing (CN)

(21) Appl. No.: 19/349,923

(22) Filed: Oct. 3, 2025

(30) Foreign Application Priority Data
Dec. 19, 2024 (CN) 202411881370.0

(51) Int. Cl. G06F 9/48; G06F 9/451; G06N 20/00

(52) U.S. Cl. CPC G06F 9/4881; G06F 9/453; G06N 20/00

(57) ABSTRACT

The disclosure provides a method, an apparatus, a device, a storage medium and a program product for task processing. The method includes: receiving a task request indicating a target task; determining, with a trained machine learning model, task information of the target task based on the task request and context information associated with the task request, where the task information at least includes interface configuration information and execution information of the target task; and presenting, based on the interface configuration information, a window interface by using an interactive widget in a process of executing the target task based on the execution information, where the window interface indicates an execution state and an execution result of the target task.

### CROSS-REFERENCE

The present application claims priority to Chinese Patent Application No. 202411881370.0, filed on Dec. 19, 2024 and entitled “METHOD, APPARATUS, DEVICE, STORAGE MEDIUM AND PROGRAM PRODUCT FOR TASK PROCESSING”, the disclosures of which are incorporated herein by reference in their entireties.

### FIELD

Example embodiments of the present disclosure generally relate to the field of computers, and in particular, to task processing.

### BACKGROUND

With the development of information technologies, various terminal devices may provide various services to people in terms of work and life. For example, an application providing a service may be deployed in the terminal device. The terminal device or the application may provide a task processing function to the user, to assist the user in using the terminal device or the application. The terminal device may receive a task request for the task, execute the task request to determine an execution result of the task, and provide the execution result to the user.

### SUMMARY

In a first aspect of the present disclosure, a method for task processing is provided. The method includes: receiving a task request indicating a target task; determining, with a trained machine learning model, task information of the target task based on the task request and context information associated with the task request, where the task information at least includes interface configuration information and execution information of the target task; and presenting, based on the interface configuration information, a window interface by using an interactive widget in a process of executing the target task based on the execution information, where the window interface indicates an execution state and an execution result of the target task.

In a second aspect of the present disclosure, an apparatus for task processing is provided. The apparatus includes: a task request receiving module configured to receive a task request indicating a target task; a task information determining module configured to determine, with a trained machine learning model, task information of the target task based on the task request and context information associated with the task request, where the task information at least includes interface configuration information and execution information of the target task; and a window interface presenting module configured to present, based on the interface configuration information, a window interface by using an interactive widget in a process of executing the target task based on the execution information, where the window interface indicates an execution state and an execution result of the target task.

In a third aspect of the present disclosure, an electronic device is provided. The device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The medium has a computer program stored thereon, and the computer program, when executed by the processor, implements the method of the first aspect.

In a fifth aspect of the present disclosure, a computer program product is provided. The product includes a computer program, where the computer program, when executed by a processor, implements the method of the first aspect of the present disclosure.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent taken in conjunction with the accompanying drawings and with reference to the following detailed description. In the drawings, the same or similar reference numbers refer to the same or similar elements, where:

FIG. 1 illustrates a schematic diagram of an example environment in which embodiments of the present disclosure may be implemented;

FIG. 2 illustrates an example of a task processing according to some embodiments of the present disclosure;

FIGS. 3A and 3B are example interfaces for task processing according to some embodiments of the present disclosure;

FIG. 4 illustrates an example of training of a machine learning model according to some embodiments of the present disclosure;

FIG. 5 illustrates a flowchart of a method for task processing according to some embodiments of the present disclosure;

FIG. 6 illustrates an exemplary structural block diagram of an apparatus for task processing according to some embodiments of the present disclosure; and

FIG. 7 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for example only and are not intended to limit the scope of the present disclosure.

In the description of the embodiments of the present disclosure, the terms “including” and the like should be understood as an open-ended inclusion, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, “in response to A” performs one step and does not imply that this step is performed immediately after “A”, but may include one or more intermediate steps.

It may be understood that the data involved in the technical solution (including but not limited to the data itself, the acquisition, use, storage or deletion of the data) should follow the requirements of the corresponding laws and regulations and related provisions.

It may be understood that, before the technical solutions disclosed in the embodiments of the present disclosure are used, the types of personal information related to the present disclosure, the usage scope, the usage scenario and the like should be notified to the user in an appropriate manner according to the relevant laws and regulations, and the authorization of the user should be obtained.

For example, in response to receiving an active request from a user, prompt information is sent to the user to explicitly prompt the user that the requested operation will need to obtain and use personal information of the user, so that the user may autonomously select whether to provide personal information to software or hardware such as an electronic device, an application, a server, a storage medium or the like executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text manner in the pop-up window. In addition, the pop-up window may further carry a selection control for the user to select “agree” or “not agree” to provide personal information to the electronic device.

It may be understood that the foregoing process of notification and obtaining a user authorization are merely illustrative, and do not constitute a limitation on implementations of the present disclosure, and other manners of meeting related laws and regulations may also be applied to implementations of the present disclosure.

As used herein, the term “model” may learn an association relationship between respective inputs and outputs from training data such that a corresponding output may be generated for a given input after training is completed. The generation of the model may be based on machine learning techniques. Deep learning is a machine learning algorithm that processes inputs and provides corresponding outputs by using a multi-layer processing unit. The neural network model is one example of a deep learning-based model. As used herein, the “model” may also be referred to as a “machine learning model”, a “learning model”, a “machine learning network”, or a “learning network”, which terms are used interchangeably herein.

A “neural network” is a deep learning-based machine learning network. The neural network is capable of processing inputs and providing respective outputs, which typically include an input layer and an output layer and one or more hidden layers between the input layer and the output layer. Neural networks used in deep learning applications typically include many hidden layers, thereby increasing the depth of the network. Respective layers of the neural network are connected in sequence such that the output of the previous layer is provided as an input to the next layer, where the input layer receives the input of the neural network and the output of the output layer serves as the final output of the neural network. Each layer of the neural network includes one or more nodes (also referred to as processing nodes or neurons), each node processing input from the previous layer.

Generally, machine learning may generally include three stages a training stage, a testing stage, and an application stage (also referred to as an inference stage). At the training stage, a given model may be trained by using a large amount of training data, and constantly updating the parameter values, until the model is able to obtain consistent inferences from the training data that satisfy the expected objectives. By training, the model may be considered to be able to learn from the training data an association from input to output (also referred to as mapping from input to output). The parameter values of the trained model are determined. In the testing stage, the test input is applied to the trained model to test whether the model may provide the correct output, thereby determining the performance of the model. The testing stage may sometimes be fused in a training stage. In the application or inference stage, the trained model may be used to process the actual model input based on the parameter value obtained by training, to determine a corresponding model output.

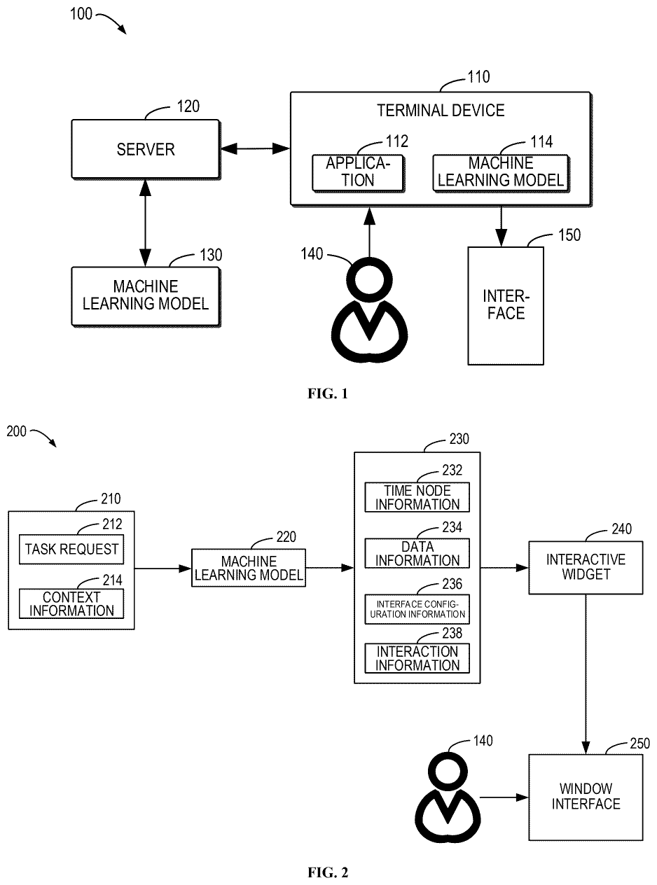

FIG. 1 illustrates a schematic diagram of an example environment 100 in which embodiments of the present disclosure may be implemented. In this example environment 100, an application 112 is installed in a terminal device 110. The user 140 may interact with the application 112 via the terminal device 110 and/or an attachment device of the terminal device 110. For example, the application 112 may acquire speech of the user 140 through a speech acquisition component (for example, a microphone) of the terminal device 110, acquire an image or video of the user 140 through an image acquisition component (for example, a camera) of the terminal device 110, and the like.

In an embodiment of the present disclosure, the application 112 may be any suitable application having a task processing function. For example, the application 112 may be a social application, a chat application, a media item application, or the like. The application 112 may, for example, provide a digital assistant for a human-machine dialogue. The digital assistant supports text-based dialogue services, speech-based dialogue services, and content dialogue in other modalities with the user 140. In some embodiments, the application 112 or digital assistant therein may utilize a machine learning model. For example, the application 112 or a digital assistant therein may utilize a machine learning model to provide a question and answer service to the user 140. The digital assistant's responses to the user may be determined based on a model output of the machine learning model.

The machine learning model may be a machine learning model (for example, a machine learning model 114) deployed on the terminal device 110, or may be a machine learning model (for example, a machine learning model 130 at the server 120) deployed at other devices. Both the machine learning model 114 and the machine learning model 130 may be based on any suitable model structure, including but not limited to a Transformer model, a convolutional neural network (CNN), a recurrent neural network (RNN), a deep neural network (DNN), or the like. In some embodiments, the machine learning model 114 and/or the machine learning model 130 may be based on a language model (LM). The language model may have question-answering capability by learning from a large amount of corpora.

In some embodiments, the language model-based machine learning model may receive model inputs in text modality (e.g., natural language and/or machine language) and/or model inputs in non-text modality (e.g., images, speech, video, etc.), and may generate the desired output from the model inputs and the prompt. The prompt herein is used to guide the machine learning model to generate a model output capable of addressing user requirements indicated by the model input. In an application scenario for supporting a user dialogue, the input of the user 140 may be provided to the machine learning model 114 and/or the machine learning model 130 as at least a portion of the model input (other portions may include prompt).

It should be noted that both the machine learning model 114 and the machine learning model 130 may include one or more machine learning models. If a plurality of machine learning models are included, the functions, structures, uses and the like of the plurality of machine learning models may be the same or different.

In the environment 100, if the application 112 is active, terminal device 110 may present a user interface (e.g., an interface 150) of the application 112. The interface 150 may include various interfaces that may be provided by the application 112, such as a dialogue interface of a user with a digital assistant (where a current dialogue and a historical dialogue may be presented, including text dialogue content), and so forth. In some embodiments, the terminal device 110 may play the speech via the interface 150, and the speech may include a question speech from the user and a response speech for the question speech.

In some embodiments, the terminal device 110 communicates with the server 120 to enable provisioning of services to the application 112. For example, the server 120 may invoke the machine learning model 130 to support a human-to-computer dialogue function between the application 112 and the user 140 based on the output of the machine learning model 130.

The terminal device 110 may be any type of mobile terminal, fixed terminal, or portable terminal, including a mobile phone, a desktop computer, a laptop computer, a notebook computer, a netbook, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the terminal device 110 may also support any type of interface for a user (such as a “wearable” circuit, etc.).

The server 120 may be a standalone physical server, a distributed system or a server cluster composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 120 may include, for example, a computing system/server, such as a mainframe, an edge computing node, a computing device in a cloud environment, or the like. The server 120 may be implemented, for example, based on a cloud environment.

It should be understood that the structures and functions of various elements in the environment 100 are described for illustrative purposes only and do not imply any limitation to the scope of the present disclosure.

As mentioned above, the terminal device may receive a task request for a task, execute a task request to determine an execution result of the task, and provide the execution result to the user. Conventionally, the terminal device may provide a specific task receiving interface, and receive a task request input by a user via the interface. In addition, if a specific operation of the user is required during the task execution, the terminal device 110 may further provide an interface corresponding to the process of task execution, and receive the user operation via the interface. As an example, if the task is an information viewing task, the user often needs to search for the desired information in a plurality of search interfaces or information display interfaces by himself or herself in order to view the searched information, which requires a large number of user operations, and is limited to the human speed, and the task execution efficiency is poor.

In view of this, according to embodiments of the present disclosure, an improved solution for task processing is provided. According to the scheme of embodiments of the present disclosure, the task request indicating a target task is received. Task information of the target task is determined, with a trained machine learning model, based on the task request and context information associated with the task request. The task information includes at least interface configuration information and execution information of the target task. In a process of executing the target task based on the execution information, a window interface is presented by using an interactive widget based on the interface configuration information, and the window interface indicates an execution state and an execution result of the target task.

In this way, the task may be automatically executed, the reliance on user interaction during the process of task execution is reduced, the user can conveniently and quickly know the execution state and result of the task through the presentation interface, and the user experience during the process of task execution can be improved.

Some example embodiments of the present disclosure will be described below with continued reference to the accompanying drawings.

FIG. 2 illustrates an example 200 of task processing according to some embodiments of the present disclosure. The example 200 may be implemented at the terminal device 110. For ease of discussion, an architecture 200 will be described with reference to the environment 100 of FIG. 1. It should be noted that the operations performed by the foregoing terminal device 110 and operations performed by the terminal device 110 described subsequently may be specifically performed by a related application (for example, the application 112) installed on the terminal device 110. In some embodiments, the operations performed on the terminal device 110 may be completed with the assistance of the server 120.

In some embodiments, the terminal device 110 may receive a task request 212 indicating the target task from the user (e.g., the user 140) in any suitable manner. For example, the terminal device 110 may receive the task request 212 input by the user via a microphone, an input box, or the like. In some embodiments, the task request 212 may include a user question for a digital assistant by a user. The terminal device 110 receives the user question in an interaction process between the user and the digital assistant. For example, the terminal device 110 may receive the user question from the user in an interaction interface of the application 112 and/or a digital assistant 114, and determine the user question as a task request 212 in response to the user question indicating a task. The task request 212 may, for example, be presented in the interaction interface in a style of a chat message from a user.

The terminal device 110 may determine a model input 210 for the machine learning model 220 based on the task request 212 and context information 214 associated with the task request 212. The context information 214 associated with the task request 212 may include, but is not limited to, historical task information (which may include a historical task request and its corresponding task information), time information related to the task request 212 (e.g., a time at which the task request 212 is received), user information associated with the task request 212 (e.g., a user name of a user triggering the task request, a user ID, a user permission, environmental information of an environment in which the user is located, a user behavior state, a historical chat of the user and the digital assistant, etc.), device information of a device (including the terminal device 110) receiving the task request 212, chat information (e.g., a chat ID of a chat receiving the task request 212, etc.), and/or the like. The device information may include, but is not limited to, environmental information of an environment in which the device is located, device state information including memory usage rate, processing system usage rate, and the like, device communication information associated with the task request 212 (for example, a path, a parameter, and header information of the task request 212). It should be emphasized that any context information mentioned in this disclosure, including context information associated with the user and context information associated with the device, is obtained and used with the knowledge and authorization of the relevant user.

The machine learning model 220 may correspond to the machine learning model 114 or the machine learning model 130 in FIG. 1. As mentioned previously, the machine learning model 220 may be based on any suitable model structure. As an example, the machine learning model 220 may be a multimodal large language model (MLM). If the machine learning model 220 corresponds to the machine learning model 114, that is, the machine learning model 220 is a machine learning model local to the terminal device 110, the terminal device 110 may directly determine the model input 210 and determine the corresponding model output by providing the model input 210 to the machine learning model 220.

If the machine learning model 220 corresponds to the machine learning model 130, that is, the machine learning model 220 is a machine learning model at another device (that is, the server 120), the terminal device 110 may invoke the machine learning model 220 deployed at another device to determine a corresponding model output based on the task request 212 and the context information 214. Specifically, in some embodiments, the terminal device 110 may locally determine the model input 210, and send the model input 210 to the server 120. In other embodiments, the terminal device 110 may directly provide the task request 212 and the context information 214 to the server 120, and the server 120 may determine the model input 210 based on the task request 212 and the context information 214 by itself in response to receiving the task request 212 and the context information 214. The server 120 may provide the model input 210 to the machine learning model 220 and obtain a corresponding model output from the machine learning model 220. The server 120 may send the model output to the terminal device 110 to enable the terminal device 110 to obtain the model output for the task request 212 and the context information 214. For ease of description, the machine learning model 220 being deployed locally on the terminal device 110 is taken as an example for illustrative description.

The model input 210 may be, for example, a prompt input. In some embodiments, the terminal device 110 may determine a prompt input for the machine learning model 220 based at least on the task request 212 and the context information 214. For example, the terminal device 110 may further determine a prompt input based on a prompt template. The terminal device 110 may determine a prompt input for the machine learning model 220 by filling the task request 212 and the context information 214 into a prompt template, and determine a model output for the prompt input with the machine learning model 220 by providing the prompt input to the machine learning model 220.

The model output may indicate task information 230 for the target task. The task information 230 includes at least interface configuration information 236 and execution information of the target task. The interface configuration information 236 may indicate a layout of the interface, content included in the interface, and the like. The execution information may include at least one of time node information 232 of the target task (which may, for example, indicate a start time, an end time, an update time, etc. of the target task), data information 234 of data associated with the target task (which may, for example, indicate data required during the process of task execution, a data source of the required data, data that needs to be output, etc.), and interaction information 238 associated with the target task (which may, for example, indicate which interaction operations are required during the process of task execution).

The terminal device 110 may perform the target task based on the execution information (that is, the time node information 232, the data information 234, and the interaction information 238). During the process of the target task execution, the terminal device 110 may further present a window interface 250 by using an interactive widget 240 based on the interface configuration information 236, and the window interface 250 may indicate an execution state and an execution result of the target task. The window interface 250 presented by the interactive widget 240 may be determined based on the interface configuration information 236. Taking ride-hailing task as an example of the target task, the execution state may include “order being confirmed”, “waiting for passengers to board”, “en route to destination”, “approaching destination”, “arrived at destination”, “order payment in progress”, or the like. The execution result may accordingly include that “order confirmed”, “vehicle has arrived at pickup location”, “payment completed”, or the like. The interactive widget may remain active on the terminal device in order to present the changed task execution state, the execution result, or the like in real time in the window interface, so that the user may always focus on the task being executed.

In some embodiments, if the target task is a task for the target application, the window interface 250 may be determined based on a user interface of the target application. As an example, the terminal device 110 may determine a user interface of a corresponding target application based on the interface configuration information 236, and determine a window interface 250 to be presented in the interactive widget 240 based on the user interface. Taking a ride-hailing task as an example of the target task, the window interface 250 may be determined based on a user interface of a ride-hailing application. The window interface 250 may be, for example, a part of the user interface of the terminal device 110.

In some embodiments, the terminal device 110 may further switch to presenting the user interface of the corresponding target application in response to receiving a specific trigger operation on the interactive widget 240. For example, the terminal device 110 may switch to presenting the target interface of the target application in response to receiving a click on the interactive widget 240. The interactive widget 240 may be regarded as an interaction control that may be presented in a screen and may be interacted with. The interactive widget 240 may be generated in real time for the target task (that is, the terminal device 110 may generate different interactive widgets for different task), or may be generated in advance (that is, different task correspond to a same interactive widget). The interactive widget 240 may be generated in any suitable manner. As an example, it may be generated by using any suitable machine learning model.

In some embodiments, the target task may include at least one subtask, for example, the subtask may be a minimum unit/minimum granularity of the task, and the subtask may also be referred to as an atomic unit, an atomic capability, or an atomic operation of the task, that is, each task may include at least one atomic unit, atomic capability, or atomic operation. It may be understood that, if a task includes only one subtask, the included subtask is the task itself. As an example, if the target task is “turn on Bluetooth and send a file to friend A through Bluetooth”, the target task may include two subtasks of “turn on Bluetooth” and “send a file to friend A through Bluetooth”.

The target task including a plurality of subtasks is taken as an example below. Regarding a determination manner of subtasks, in some embodiments, the terminal device 110 may determine, based on semantics of the task request, a target task corresponding to the task request and a plurality of subtasks included in the target task. In some embodiments, the terminal device 110 may further determine a keyword in the task request, and determine a target task corresponding to the task request and a plurality of subtasks included in the target task in a keyword matching manner. In some embodiments, the terminal device 110 may further determine, by using an appropriate machine learning model, the target task and a plurality of subtasks included in the target task based on the task request. It may be understood that the terminal device 110 may determine the plurality of subtasks in any suitable manner, which is not limited in the present disclosure. It should be noted that, if the target task includes a plurality of subtasks, the window interface 250 may further indicate an execution state and an execution result of each subtask.

In some embodiments, in a process of executing the target task, if it is determined that a first subtask of the plurality of subtasks requires a user input, the window interface 250 may present an input control for receiving the user input. As an example, the input control may include an input box, an option, and an operation control and any appropriate type of control. The terminal device 110 may receive a user input via an input control. The terminal device 110 may receive a user input in a text form, for example, via an input box. When the window interface 250 includes a plurality of options, the terminal device 110 may determine, in response to receiving a selection of at least one option of the plurality of options by a user, content corresponding to the at least one option as the user input.

The operation control may include a speech control, a file upload control, a determination control, or the like. The terminal device 110 may receive a trigger for a speech control, and acquire audio by using a microphone. The terminal device 110 may further receive, in response to receiving a trigger for the text upload control, a user input of any suitable type, such as a file type, an image type, a video type, or the like, uploaded by the user. The window interface 250 may also be presented with recommended content for a user input, and the terminal device 110 may determine the recommended content as the user input in response to a trigger for the determination control. The recommended content may be determined based on historical task information of the user, or may be determined based on other subtask(s) of the plurality of subtasks of the target task that is/are located before the current subtask. For example, the recommended content may be an execution result of other subtask(s) before the current subtask. The terminal device 110 may perform a first task based at least on the received user input.

As an example, the target task may be reserving an airline ticket for a target date, the window interface 250 may present a recommended flight, and the recommended flight may be determined based on a historical airline reservation record of the user. The terminal device 110 may determine, in response to receiving a determination operation for the recommended flight, the recommended flight as the user input, and then perform an airline reservation task according to the recommended flight. Therefore, the user does not need to select a flight and preset an airline ticket, the recommended flight to be recommended to the user may be determined automatically from a plurality of flights, the ticket may be reserved automatically, which can reduce the reliance on the user interaction in the task execution process.

In some embodiments, the interactive widget 240 may have a plurality of visual styles, and presentation sizes corresponding to the plurality of visual styles may be different. For example, the interactive widget 240 may be presented with a smaller first size by default and may be switched to be presented with a second size having a larger size in response to being triggered (e.g., clicked). It may be understood that, compared with the first size, in the case that it is presented with the second size, the size of the window interface 250 that may be presented by the interactive widget 240 is larger, and more content may be presented.

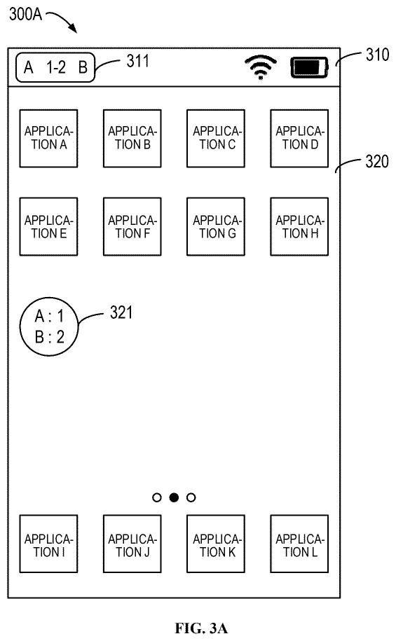

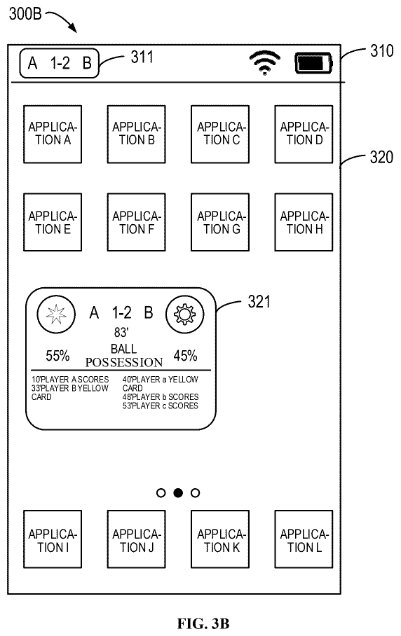

Referring to FIGS. 3A and 3B, FIGS. 3A and 3B illustrate an example interface 300A and an example interface 300B for task processing according to some embodiments of the present disclosure. As shown in FIG. 3A, the example interface 300A may include a region 310 and a region 320, and the terminal device 110 may, for example, switch content presented in the region 320 in response to receiving an interface switching operation (for example, a left-right sliding operation). Regardless of whether the content in the region 320 changes, the terminal device 110 may maintain presentation of the region 310. The terminal device 110 may present an interactive widget 311 in the region 310, or may present an interactive widget 321 in the region 320.

The terminal device 110 may also, for example, move a presentation position of the interactive widget 321 in the region 320 in response to receiving a dragging operation on the interactive widget 321. The terminal device 110 may present the example interface 300B in response to receiving a trigger operation for the interactive widget 321. A presentation size of the interactive widget 321 in the example interface 300B may be larger than a presentation size of the interactive widget 321 in the example interface 300A.

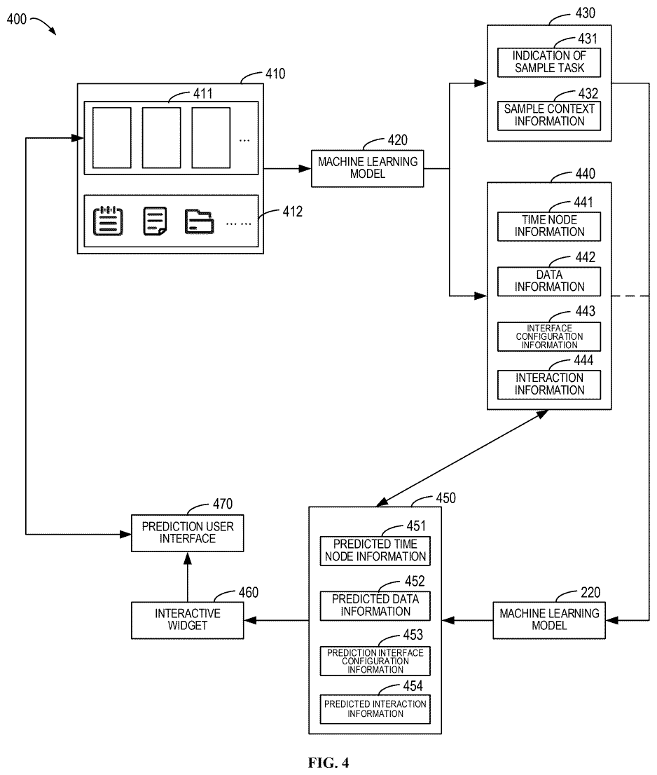

The application of the machine learning model 220 is described above with reference to FIGS. 2 to 3B, and a training process of the machine learning model 220 is described below with reference to FIG. 4. FIG. 4 illustrates an example 400 of training of the machine learning model 220 according to some embodiments of the present disclosure. It should be noted that the machine learning model 220 may be trained at the terminal device 110, the server 120, or any other suitable electronic device. Herein, for illustrative purposes only, the training of the machine learning model 220 at the terminal device 110 is described as an example.

In some embodiments, the terminal device 110 may perform pre-training and supervised training on the machine learning model 220. Specifically, the terminal device 110 may perform pre-training on the machine learning model 220 by performing a mask on a part of first sample data, and may perform supervised training on the pre-trained machine learning model 220 based on second sample data. The machine learning model 220 is pre-trained to enable masked part of data to be predictable from masked sample data. The main purpose of masked training is to improve the understanding and generation ability of the model by filling blank or predicting hidden content, making it perform better when processing unseen data. Through the masked training method, the model can more effectively understand and generate data, and the performance of the model in various tasks can be improved. This training technique is widely used in pre-training models and generation tasks of natural language processing and computer vision. The process of performing supervised training may also be referred to as a supervised fine-tuning (SFT) stage of the machine learning model 220.

The first sample data and the second sample data may include the same sample data, or may include different sample data. Both the first sample data and the second sample data may include an indication of a sample task, sample context information associated with the sample task, and sample task information of the sample task. Referring to FIG. 4, the first sample data/second sample data may include an indication 431 of a sample task, sample context information 432 associated with the sample task, and sample task information 440 of the sample task. It may be understood that the sample task information 440 may include at least interface configuration information 443 and execution information of the sample task. The execution information may include at least one of time node information 441 of the sample task, data information 442 of data associated with the sample task, and interaction information 444 associated with the sample task.

Regarding the manner of obtaining the first sample data/the second sample data, in some embodiments, the terminal device 110 may obtain a plurality of user interfaces 411 and logs 412 of at least one application acquired in a process of executing the sample task by using the at least one application, and determine the first sample data/the second sample data based on the plurality of user interfaces 411 and the logs 412. The user interface 411 may include various interfaces that may be provided in a process of executing a sample task, and as an example, may include an interaction interface for interacting with a user in a process of executing a sample task. For example, if the sample task is a ride-hailing task, the user interface 411 may include an address selection interface of a ride-hailing application (which may be configured to determine a departure place and a destination of the ride), a vehicle type selection interface, an order payment interface, a navigation interface, or the like.

The log 412 may be a file that records events, activities, transactions, or information. In a software system, the logs 412 are usually used to track a running process of an application, a user behavior, an error condition, or the like. These records are useful for debugging, monitoring, and maintaining systems. The terminal device 110 may also analyze the logs 412 to determine an event (Event) in the logs 412, which generally refers to a specific event or behavior occurring in the system or the application. This may include user operations (e.g., logging in, clicking on buttons, submitting forms, etc.), system behaviors (e.g., starting, stopping, requests, responses, etc.), errors and exceptions (e.g., crashes, error codes, exception thrown, etc.), etc. As such, the first sample data/second sample data may be determined based on the user interface 411, the logs 412, and the event.

The terminal device 110 may determine the first sample data/the second sample data based on the plurality of user interfaces 411 and the logs 412 in any suitable manner. In some embodiments, the terminal device 110 may extract the first sample data or the second sample data from the plurality of user interfaces 411 and the logs 412 by using another trained machine learning model (that is, the machine learning model 420, which may be referred to as a sample determining model). Similar to the machine learning model 220, the machine learning model 420 may likewise be based on any suitable model structure. Merely by way of example, the machine learning model 420 may be a multimodal large language model with a graphical user interface (GUI) understanding capability.

The terminal device 110 may determine a model input 410 for the machine learning model 420 based on the plurality of user interfaces 411 and the logs 412. The model input 410 may be, for example, a prompt input. In some embodiments, the terminal device 110 may determine a prompt input for the machine learning model 420 based at least on the plurality of user interfaces 411 and the logs 412. For example, the terminal device 110 may further determine the prompt input based on a prompt template configured to indicate to generate the sample data. Referring to Table 1, Table 1 shows an example of the prompt template:

TABLE 1
## character setting
**You are an agent with GUI understand capabilities. Your task is to analyze and decompose
based on these inputs, and output the corresponding task output parameters and task input
parameters.
## function-1 good at analysis
1. Based on the input, key processes and interaction results in the data are analyzed to infer
the underlying logic and decision process.
## functio-2 good at decomposition
1. Based on the analysis results, they are decomposed into two parts: input and output
2. Task input parameters include: task request, context information
3. Task output parameters include: task information
## workflow
1. receiving input
2. analyzing model input by using function-1
3. decomposing the analysis result by using function-2
4. outputting result
## Input as follows:
1. a plurality of user interfaces:
2. logs:
## Output as follows:
1. Task input parameters:
2. Task output parameters:

The terminal device 110 may determine the prompt input for the machine learning model 420 by filling the plurality of user interfaces 411 and the logs 412 into the prompt template shown in Table 1, and determine the corresponding first sample data/second sample data with the machine learning model 420 by providing the prompt input to the machine learning model 420.

It should be noted that, the foregoing process of determining the sample data (that is, the first sample data/the second sample data) may be implemented at the terminal device 110, or may be implemented at other electronic device(s) (that is, the machine learning model 420 may be deployed at other electronic device(s)), and merely the implementation at the terminal device 110 is taken as an example for illustrative description. If the sample data is determined at other electronic device(s), the terminal device 110 for training the machine learning model 220 may obtain the sample data directly from other electronic device(s) based on the communication connection with other electronic device(s).

It may be understood that the indication 431 of the sample task in the first sample data/the second sample data may correspond to the task request 212 described above. The difference between the two lies in that the indication 431 of the sample task in the first sample data/second sample data is determined by using the machine learning model 420, while the task request 212 may be input by a user.

The terminal device 110 may refer to the indication 431 of the sample task and the sample context information 432 associated with the sample task as sample input 430. During the process of performing supervised training on the machine learning model 220, the terminal device 110 may determine predicted task information 450 corresponding to the sample input 430, for example, by providing the sample input 430 in the second sample data to the machine learning model 220. The predicted task information 450 may include at least predicted execution information and prediction interface configuration information 453 of the sample task. The predicted execution information may include at least one of predicted time node information 451 of the sample task, predicted data information 452 of data associated with the sample task, and predicted interaction information 454 associated with the sample task.

The terminal device 110 may, for example, determine a difference between the sample task information 440 and the predicted task information 450, and determine a loss based on the difference (the loss may be referred to as a first loss). For example, the terminal device 110 may determine the first loss by using any suitable loss function (“Loss Function”, which may also be referred to as a cost function or an error function). The loss function is a function for measuring a difference between a model prediction result and an actual target in the machine learning and training of a deep learning model. An output value of the loss function is used to guide updating of a model parameter to gradually reduce the error, thereby improving the prediction precision of the model. The terminal device 110 may train the machine learning model 220 based at least on the first loss.

Therefore, in a process of performing supervised training on the machine learning model 220, the terminal device may train the machine learning model 220 based on at least the first loss, and the trained machine learning model 220 may generate more accurate predicted task information, which may improve the performance of the machine learning model 220 in the task processing.

In some embodiments, the terminal device 110 may further perform the sample task based on the predicted execution information (that is, the predicted time node information 451, the predicted data information 452, and the predicted interaction information 454), and in the execution process of the sample task, present a prediction window interface by using an interactive widget 460 based on the prediction interface configuration information 453. This prediction window interface may indicate an execution state and execution result of the sample task. The prediction window interface presented by the interactive widget 460 may be determined based on the prediction interface configuration information 453. The prediction window interface may be determined based on a prediction user interface 470. The terminal device 110 may determine a corresponding prediction user interface 470 based on the prediction interface configuration information 453, and determine a prediction window interface presented by the interactive widget 460 based on the prediction user interface 470. It may be understood that both the prediction user interface 470 and the prediction window interface may include a plurality of interfaces.

In some embodiments, the second sample data may further include a sample user interface of the at least one application acquired in a process of executing the sample task by using the at least one application. As an example, the second sample data may include a sample input 430, sample task information 440, and a plurality of user interfaces 411. That is, the terminal device 110 may determine the plurality of user interfaces 411 used to determine the second sample data as part of the second sample data. In this case, the plurality of user interfaces may be referred to as sample user interfaces for at least one application.

The terminal device 110 may, for example, determine a difference between the prediction user interface 470 and the sample user interface (i.e., the plurality of user interfaces 411), and determine a loss based on the difference (which may be referred to as a second loss). For example, the terminal device 110 may determine the second loss by using any suitable pixelwise loss function. The pixelwise loss function is a function of calculating an error between a predicted value and a true value of each pixel in the image processing task. This loss function is applicable to tasks such as super resolution, image reconstruction, image segmentation, or the like. The terminal device 110 may then train the machine learning model 220 based on the first loss and the second loss.

Therefore, in the process of performing supervised training on the machine learning model 220, the terminal device may train the machine learning model 220 based on the first loss and the second loss, and the trained machine learning model 220 may generate more accurate predicted task information and present a more accurate window interface by using the interactive widget, which can further improve the performance of the machine learning model 220 in the task processing.

In some embodiments, in the application stage and/or the training stage of the machine learning model 220, the terminal device 110 may further obtain user feedback information for the window interface (which may include a window interface of the application stage and/or a prediction window interface of the training stage). For example, the terminal device 110 may present a feedback obtaining interface, and obtain user feedback information input by the user via the interface. The user feedback information may include user ratings, user recommendations, or the like. The user feedback information may indicate a user preference, a modification opinion, or a satisfaction degree for the window interface, or the like. The terminal device 110 may update the machine learning model 220 by reinforcement learning based on the user feedback information, which stage may be referred to as a human feedback reinforcement learning (HFRL) stage. As an example, the terminal device 110 may adjust parameters, weights, strategies, or the like of the machine learning model 220 based on the user feedback information, so that the performance of the machine learning model is further optimized, and the user expectations can be better met.

In summary, according to various embodiments of the present disclosure, the interface configuration information of the task may be determined by means of a machine learning model, and the window interface is presented by using the interactive widget based on the interface configuration information, where the window interface indicates an execution state and an execution result of the task. The task may be automatically executed, the reliance on user interaction in the task execution process is reduced, the user can conveniently and quickly know the execution state and result of the task by presenting the interface, and the user experience of the user in the task execution process can be improved.

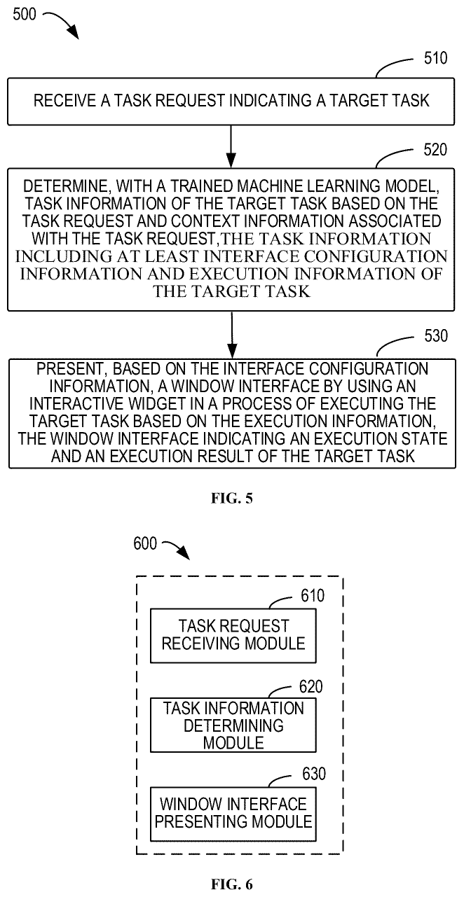

FIG. 5 shows a flowchart of a method 500 for task processing according to some embodiments of the present disclosure. The method 500 may be implemented at the terminal device 110.

At block 510, the terminal device 110 receives a task request indicating a target task.

At block 520, the terminal device 110 determines, with a trained machine learning model, task information of the target task based on the task request and context information associated with the task request, where the task information includes at least interface configuration information and execution information of the target task.

At block 530, the terminal device 110 presents, based on the interface configuration information, a window interface by using an interactive widget in a process of executing the target task based on the execution information, where the window interface indicates an execution state and an execution result of the target task.

In some embodiments, the target task includes a plurality of subtasks, and the method 500 further includes: presenting, in response to determining that a first subtask of the plurality of subtasks requires a user input, an input control for receiving the user input via the window interface in a process of executing the target task; receiving the user input via the input control; and executing the first subtask based on at least the user input.

In some embodiments, determining the task information of the target task includes: determining a prompt input for the machine learning model based at least on the task request and the context information; and determining the task information with the machine learning model by providing the prompt input to the machine learning model.

In some embodiments, the context information indicates at least one of: historical task information, time information related to the task request, user information associated with the task request, or device information associated with the task request. In some embodiments, the execution information indicates at least one of: time node information of the target task, data information of data associated with the target task, or interaction information associated with the target task.

In some embodiments, the machine learning model is trained via at least one of: pre-training the machine learning model by performing a mask on a part of first sample data, where the machine learning model is pre-trained to enable masked part of data to be predictable from masked sample data; and performing supervised training on the pre-trained machine learning model based on second sample data, where the first sample data or the second sample data includes an indication of a sample task, sample context information associated with the sample task, and sample task information of the sample task.

In some embodiments, the first sample data or the second sample data is obtained by: obtaining a plurality of user interfaces and logs of at least one application acquired in a process of executing the sample task by using the at least one application; and determining the first sample data or the second sample data based on the plurality of user interfaces and the logs.

In some embodiments, determining the first sample data or the second sample data based on the plurality of user interfaces and the logs includes: extracting, by using a further trained machine learning model, the first sample data or the second sample data from the plurality of user interfaces and the logs.

In some embodiments, performing supervised training on the machine learning model based on the sample data of the sample task includes: determining, based on the indication of the sample task and the sample context information, predicted task information of the target task by using the machine learning model; and training the machine learning model based at least on a first loss between the sample task information and the predicted task information.

In some embodiments, the second sample data includes a sample user interface of at least one application acquired in a process of executing the sample task by using the at least one application, the predicted task information includes at least prediction interface configuration information of the sample task, and training the machine learning model includes: determining a prediction user interface of the interactive widget based on the prediction interface configuration information; determining a second loss based on a difference between the prediction user interface and the sample user interface; and training the machine learning model based on the first loss and the second loss.

In some embodiments, the method 500 further includes: obtaining user feedback information for the window interface; and updating the machine learning model by reinforcement learning based on the user feedback information.

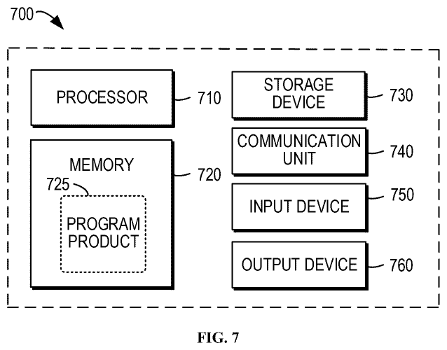

Embodiments of the present disclosure also provide a corresponding apparatus for implementing the above method or process. FIG. 6 illustrates an example structural block diagram of an apparatus 600 for task processing according to some embodiments of the present disclosure. The apparatus 600 may be implemented or included in the terminal device 110. The various modules/components in the apparatus 600 may be implemented by hardware, software, firmware, or any combination thereof.

As shown in FIG. 6, the apparatus 600 includes a task request receiving module 610 configured to receive a task request indicating a target task. The apparatus 600 further includes a task information determining module 620 configured to determine, with a trained machine learning model, task information of the target task based on the task request and context information associated with the task request, where the task information includes at least interface configuration information and execution information of the target task. The apparatus 600 further includes a window interface presenting module 630 configured to present, based on the interface configuration information, a window interface by using an interactive widget in a process of executing the target task based on the execution information, where the window interface indicates an execution state and an execution result of the target task.

In some embodiments, the target task includes a plurality of subtasks, and the apparatus 600 further includes: an input control presenting module configured to present, in response to determining that a first subtask of the plurality of subtask requires a user input, an input control for receiving the user input via the window interface in a process of executing the target task; a user input receiving module configured to receive the user input via the input control; and a subtask executing module configured to execute the first subtask based on at least the user input.

In some embodiments, the task information determining module 620 is further configured to: determine a prompt input for the machine learning model based at least on the task request and the context information; and determine the task information with the machine learning model by providing the prompt input to the machine learning model.

In some embodiments, the context information indicates at least one of: historical task information, time information related to the task request, user information associated with the task request, or device information associated with the task request, and the execution information indicates at least one of: time node information of the target task, data information of data associated with the target task, or interaction information associated with the target task.

In some embodiments, the machine learning model is trained via at least one of: pre-training the machine learning model by performing a mask on a part of first sample data, where the machine learning model is pre-trained to enable masked part of data to be predictable from masked sample data; and performing supervised training on the pre-trained machine learning model based on second sample data, where the first sample data or the second sample data includes an indication of a sample task, sample context information associated with the sample task, and sample task information of the sample task.

In some embodiments, the first sample data or the second sample data is obtained by: obtaining a plurality of user interfaces and logs of at least one application acquired in a process of executing the sample task by using the at least one application; and determining the first sample data or the second sample data based on the plurality of user interfaces and the logs.

In some embodiments, determining the first sample data or the second sample data based on the plurality of user interfaces and the log includes: extracting, by using a further trained machine learning model, the first sample data or the second sample data from the plurality of user interfaces and the logs.

In some embodiments, performing supervised training on the machine learning model based on the sample data of the sample task includes: determining, based on the indication of the sample task and the sample context information, predicted task information of the target task by using the machine learning model; and training the machine learning model based at least on a first loss between the sample task information and the predicted task information.

In some embodiments, the second sample data includes a sample user interface of at least one application acquired in a process of executing the sample task by using the at least one application, the predicted task information includes at least prediction interface configuration information of the sample task, and training the machine learning model includes: determining a prediction user interface of the interactive widget based on the prediction interface configuration information; determining a second loss based on a difference between the prediction user interface and the sample user interface; and training the machine learning model based on the first loss and the second loss.

In some embodiments, the apparatus 600 further includes: a feedback information obtaining module configured to obtain user feedback information for the window interface; and a model updating module configured to update the machine learning model through reinforcement learning based on the user feedback information.

The modules included in the apparatus 600 may be implemented in various manners, including software, hardware, firmware, or any combination thereof. In some embodiments, one or more modules may be implemented by using software and/or firmware, such as machine-executable instructions stored on a storage medium. In addition to or as an alternative to machine-executable instructions, some or all of the modules in the apparatus 600 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), or the like.

It should be understood that one or more steps of the above method may be performed by a suitable electronic device or a combination of electronic devices. Such an electronic device or a combination of electronic devices may include, for example, the terminal device 110 in FIG. 1.

FIG. 7 illustrates a block diagram of an electronic device 700 in which one or more embodiments of the present disclosure may be implemented. It should be understood that the electronic device 700 illustrated in FIG. 7 is merely illustrative and should not constitute any limitation on the functionality and scope of the embodiments described herein. The electronic device 700 shown in FIG. 7 may be configured to implement the terminal device 110 in FIG. 1 or the apparatus 600 in FIG. 6.

As shown in FIG. 7, the electronic device 700 is in the form of a general-purpose electronic device. Components of the electronic device 700 may include, but are not limited to, one or more processing units or processors 710, a memory 720, a storage device 730, one or more communication units 740, one or more input devices 750, and one or more output devices 760. The processor 710 may be an actual or virtual processor and capable of performing various processes according to programs stored in the memory 720. In multiprocessor systems, multiple processing units execute computer-executable instructions in parallel to improve parallel processing capabilities of the electronic device 700.

The electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, magnetic disk, or any other medium, which may be capable of storing information and/or data and may be accessed within the electronic device 700.

The electronic device 700 may further include additional removable/non-removable, volatile/non-volatile storage media. Although not shown in FIG. 7, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 is configured to communicate with another electronic device through a communication medium. Additionally, the functionality of components of the electronic device 700 may be implemented in a single computing cluster or multiple computing machines capable of communicating over a communication connection. Thus, the electronic device 700 may operate in a networked environment using logical connections with one or more other servers, network personal computers (PCs), or another network node.

The input device 750 may be one or more input devices, such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed, the external devices, such as storage devices, display devices, or the like, communicate with one or more devices that enable a user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the method described above. According to example implementations of the present disclosure, a computer program product is further provided, the computer program product being tangibly stored on a non-transitory computer-readable medium and including computer-executable instructions, and the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in one or more blocks in the flowchart and/or block diagram. These computer-readable program instructions may also be stored in a computer-readable storage medium, and these instructions cause the computer, programmable data processing apparatus, and/or other devices to function in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto a computer, other programmable data processing apparatus, or other apparatus, such that a series of operational steps are performed on the computer, other programmable data processing apparatus, or other apparatus to produce a computer-implemented process such that the instructions executed on the computer, other programmable data processing apparatus, or other apparatus implement the functions/acts specified in one or more blocks in the flowchart and/or block diagram.

The flowcharts and block diagrams in the figures show architecture, functionality, and operation of possible implementations of systems, methods, and computer program products according to various implementations of the present disclosure. In this regard, each block in the flowchart or block diagram may represent a module, program segment, or portion of instruction that includes one or more executable instructions for implementing the specified logical function. In some implementations as an update, the functions noted in the blocks may also occur in a different order than that shown in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for task processing, comprising:
receiving a task request indicating a target task;
determining, with a trained machine learning model, task information of the target task based on the task request and context information associated with the task request, wherein the task information comprises at least interface configuration information and execution information of the target task; and
presenting, based on the interface configuration information, a window interface by using an interactive widget in a process of executing the target task based on the execution information, wherein the window interface indicates an execution state and an execution result of the target task.

2. The method of claim 1, wherein the target task comprises a plurality of subtasks, and the method further comprises:
presenting, in response to determining that a first subtask of the plurality of subtasks requires a user input, an input control for receiving the user input via the window interface in a process of executing the target task;
receiving the user input via the input control; and
executing the first subtask based at least on the user input.

3. The method of claim 1, wherein determining the task information of the target task comprises:
determining a prompt input for the machine learning model based at least on the task request and the context information; and
determining the task information with the machine learning model by providing the prompt input to the machine learning model.

4. The method of claim 1, wherein the context information indicates at least one of: historical task information, time information related to the task request, user information associated with the task request, or device information associated with the task request, and
the execution information indicates at least one of: time node information of the target task, data information of data associated with the target task, or interaction information associated with the target task.

5. The method of claim 1, wherein the machine learning model is trained via at least one of:
pre-training the machine learning model by performing a mask on a part of first sample data, wherein the machine learning model is pre-trained to enable masked part of data to be predictable from masked sample data; and
performing supervised training on the pre-trained machine learning model based on second sample data,
wherein the first sample data or the second sample data comprises an indication of a sample task, sample context information associated with the sample task, and sample task information of the sample task.

6. The method of claim 5, wherein the first sample data or the second sample data is obtained by:
obtaining a plurality of user interfaces and logs of at least one application acquired in a process of executing the sample task by using the at least one application; and
determining the first sample data or the second sample data based on the plurality of user interfaces and the logs.

7. The method of claim 6, wherein determining the first sample data or the second sample data based on the plurality of user interfaces and the logs comprises:
extracting, by using a further trained machine learning model, the first sample data or the second sample data from the plurality of user interfaces and the logs.

8. The method of claim 5, wherein performing supervised training on the machine learning model based on sample data of the sample task comprises:
determining, based on the indication of the sample task and the sample context information, predicted task information of the target task by using the machine learning model; and
training the machine learning model based at least on a first loss between the sample task information and the predicted task information.

9. The method of claim 8, wherein the second sample data comprises a sample user interface of at least one application acquired in a process of executing the sample task by using the at least one application, the predicted task information at least comprises prediction interface configuration information of the sample task, and training the machine learning model comprises:
determining a prediction user interface of the interactive widget based on the prediction interface configuration information;
determining a second loss based on a difference between the prediction user interface and the sample user interface; and
training the machine learning model based on the first loss and the second loss.

10. The method of claim 1, further comprising:
obtaining user feedback information for the window interface; and
updating the machine learning model by reinforcement learning based on the user feedback information.

11. An electronic device, comprising:
at least one processor; and
at least one memory coupled to the at least one processor and storing instructions for execution by the at least one processor, the instructions, when executed by the at least one processor, causing the electronic device to perform acts comprising:
receiving a task request indicating a target task;
determining, with a trained machine learning model, task information of the target task based on the task request and context information associated with the task request, wherein the task information comprises at least interface configuration information and execution information of the target task; and
presenting, based on the interface configuration information, a window interface by using an interactive widget in a process of executing the target task based on the execution information, wherein the window interface indicates an execution state and an execution result of the target task.

12. The electronic device of claim 11, wherein the target task comprises a plurality of subtasks, and the acts further comprise:
presenting, in response to determining that a first subtask of the plurality of subtasks requires a user input, an input control for receiving the user input via the window interface in a process of executing the target task;
receiving the user input via the input control; and
executing the first subtask based at least on the user input.

13. The electronic device of claim 11, wherein determining the task information of the target task comprises:
determining a prompt input for the machine learning model based at least on the task request and the context information; and
determining the task information with the machine learning model by providing the prompt input to the machine learning model.

14. The electronic device of claim 11, wherein the context information indicates at least one of: historical task information, time information related to the task request, user information associated with the task request, or device information associated with the task request, and
the execution information indicates at least one of: time node information of the target task, data information of data associated with the target task, or interaction information associated with the target task.

15. The electronic device of claim 11, wherein the machine learning model is trained via at least one of:
pre-training the machine learning model by performing a mask on a part of first sample data, wherein the machine learning model is pre-trained to enable masked part of data to be predictable from masked sample data; and
performing supervised training on the pre-trained machine learning model based on second sample data,
wherein the first sample data or the second sample data comprises an indication of a sample task, sample context information associated with the sample task, and sample task information of the sample task.

16. The electronic device of claim 15, wherein the first sample data or the second sample data is obtained by:
obtaining a plurality of user interfaces and logs of at least one application acquired in a process of executing the sample task by using the at least one application; and
determining the first sample data or the second sample data based on the plurality of user interfaces and the logs.

17. The electronic device of claim 16, wherein determining the first sample data or the second sample data based on the plurality of user interfaces and the logs comprises:
extracting, by using a further trained machine learning model, the first sample data or the second sample data from the plurality of user interfaces and the logs.

18. The electronic device of claim 15, wherein performing supervised training on the machine learning model based on sample data of the sample task comprises:
determining, based on the indication of the sample task and the sample context information, predicted task information of the target task by using the machine learning model; and
training the machine learning model based at least on a first loss between the sample task information and the predicted task information.

19. The electronic device of claim 18, wherein the second sample data comprises a sample user interface of at least one application acquired in a process of executing the sample task by using the at least one application, the predicted task information at least comprises prediction interface configuration information of the sample task, and training the machine learning model comprises:
determining a prediction user interface of the interactive widget based on the prediction interface configuration information;
determining a second loss based on a difference between the prediction user interface and the sample user interface; and
training the machine learning model based on the first loss and the second loss.

20. A non-transitory computer-readable storage medium having a computer program stored thereon, wherein the computer program is executable by a processor to implement acts comprising:
receiving a task request indicating a target task;
determining, with a trained machine learning model, task information of the target task based on the task request and context information associated with the task request, wherein the task information comprises at least interface configuration information and execution information of the target task; and
presenting, based on the interface configuration information, a window interface by using an interactive widget in a process of executing the target task based on the execution information, wherein the window interface indicates an execution state and an execution result of the target task.
